(19) United States
(12) Patent Application Publication
(10) Pub. No.: US 2026/0319148 A1
(43) Pub. Date: Oct. 15, 2026

(54) TRANSMISSION GRATING AND PREPARATION METHOD THEREOF

(71) Applicant: SOOCHOW UNIVERSITY, Suzhou (CN)

(72) Inventors: Quan LIU, Suzhou (CN); Jiang LENG, Suzhou (CN); Kexin WANG, Suzhou (CN); Xingyu CHEN, Suzhou (CN); Tao LIU, Suzhou (CN); Zhiwei CHEN, Suzhou (CN)

(73) Assignee: SOOCHOW UNIVERSITY, Suzhou (CN)

(21) Appl. No.: 19/691,067

(22) Filed: May 28, 2026

Related U.S. Application Data
(63) Continuation of application No. PCT/CN2025/119708, filed on Sep. 8, 2025.

(30) Foreign Application Priority Data
Sep. 11, 2024 (CN) 202411270555.8

(51) Int. Cl. G02B 5/18

(52) U.S. Cl. CPC G02B 5/1866; G02B 5/1847; G02B 2005/1804

(57) ABSTRACT

The disclosure provides a transmission grating and a preparation method thereof. The transmission grating includes a substrate having a first surface; a grating layer, including trapezoidal grating teeth arranged on the first surface, where a gap is formed between two adjacent grating teeth; and a dielectric layer, disposed on a surface of the grating layer and filling the gap, where a side of the dielectric layer away from the substrate has a second surface, and the distance between the second surface and the first surface differs from the height of the grating layer by a value of m; and incident light is incident toward the second surface through an interior of the grating layer. By designing the film layer structure and dimensions of the transmission grating, transmission gratings having different diffraction efficiencies and degrees of polarization can be obtained.

### FIELD OF THE INVENTION

The present disclosure relates to the technical field of gratings, and in particular, to a transmission grating and a preparation method therefor.

### BACKGROUND

Grating-based hyperspectral imagers are widely used devices. The design and manufacture of hyperspectral imagers require a comprehensive technology that combines optics, spectroscopy, computer science, remote sensing technology, data processing, and other disciplines. With the development of technology, dispersive elements combining gratings and prisms have appeared in imaging spectrometer systems. Unlike conventional gratings, the groove profile of a prism grating is immersed in a high-refractive-index medium, such as SiO₂ or Si. Because the groove profile of the prism grating is embedded in the high-refractive-index medium, the angular dispersion and the resolution of the grating are both increased by a factor of n, where n is the refractive index of the high-refractive-index medium. Therefore, compared with conventional gratings, the prism grating can reduce the dimensions of the grating while achieving the same spectral resolution, thereby achieving a more compact design. This is particularly suitable for high-resolution spectrometers used for atmospheric greenhouse gas detection. In the published Chinese patent CN111708113A, a metal reflective immersion grating with low polarization and high diffraction efficiency and an optical system are provided, which specifically discloses a reflective grating structure having a rectangular groove profile.

However, in practical processing processes, the groove profile of the grating is mostly trapezoidal. Compared with rectangular groove profiles, the trapezoidal groove profiles reduce the difficulty of the processing process. However, how to accurately fill the gaps of the trapezoidal groove profiles while ensuring that the transmission diffraction efficiency can reach a high level over the entire wavelength band and that a low degree of polarization can be achieved becomes an urgent problem to be addressed. Accordingly, there is an urgent need to provide a transmission grating that is easy to process.

### SUMMARY OF THE INVENTION

Therefore, the technical problem to be addressed by the present disclosure is to overcome the defects in the prior art and provide a transmission grating and a preparation method therefor. In the present disclosure, by designing the film layer structure and film layer dimensions of the transmission grating, transmission gratings having different diffraction efficiencies and degrees of polarization can be obtained, and the dimensions of the film layer structure of the transmission gratings can be precisely controlled during processing, thereby facilitating processing.

To address the above technical problem, the present disclosure provides a transmission grating, including:
a substrate having a first surface;
a grating layer, including trapezoidal grating teeth arranged in an array on the first surface, where a gap is formed between two adjacent grating teeth; and
a dielectric layer, disposed on a surface of the grating layer and filling the gap, where a side of the dielectric layer away from the substrate has a second surface, and a difference exists between a distance from the second surface to the first surface and a height of the grating layer, the difference being denoted as m,
where incident light is incident toward the second surface through an interior of the grating layer, and a diffraction effect occurs in the grating layer, the dielectric layer, and the second surface to generate transmitted diffracted light, the transmitted diffracted light being emitted through the second surface of the dielectric layer.

In one embodiment of the present disclosure, the dielectric layer includes a first film layer and a second film layer, the first film layer covers the grating layer and a portion of the substrate, the second film layer covers the first film layer, a thickness of the first film layer is denoted as m1, a thickness of the second film layer is denoted as m2, and m=m1+m2.

In one embodiment of the present disclosure, a cross-sectional shape of the grating tooth in a height direction of the grating layer is an isosceles trapezoid, and a slanted side angle θ of the grating tooth is 83 degrees to 88 degrees.

In one embodiment of the present disclosure, a period A of the grating is 700 nm to 2000 nm, a width of a bottom of the grating tooth is denoted as a, a width of a middle of the grating tooth is denoted as b, the height of the grating layer is denoted as H, a middle duty cycle f_{middle}=(b/∧) is 0.39 to 0.48, and an aspect ratio (H/A) is 1.65 to 1.76.

In one embodiment of the present disclosure, the slanted side angle θ of the grating tooth is 83 degrees to 88 degrees, and a calculation formula of the difference m is defined as formula 1:

$$m = {m}_{1} + {m}_{2} = \frac{p}{tan ( \frac{θ}{2} )} + \frac{H cos ( θ )}{1 - cos ( θ )} , where$$

$$p = \frac{( 1 - {f}_{bottom} ) Λ}{2} and$$

$${f}_{bottom} = {f}_{middle} + \frac{H}{tan ( θ ) Λ} .$$

In one embodiment of the present disclosure, the dielectric layer includes titanium dioxide (TiO₂), aluminum oxide (Al₂O₃), and tantalum pentoxide (Ta₂O₅).

In one embodiment of the present disclosure, the substrate is made of fused silica optical glass. The present disclosure further provides a preparation method for a transmission grating, where the method is used for preparing the transmission grating described above, and the preparation method includes:
step S1, selecting a substrate, coating the substrate with a photoresist, exposing the substrate coated with a photoresist film, and developing the exposed substrate in a developer to obtain a photoresist grating mask;
step S2, performing mask transfer by ion beam etching to transfer a grating mask pattern onto a surface of the substrate to form a grating layer; and
step S3, removing remaining photoresist, and forming a dielectric layer on a surface of the grating layer by atomic layer deposition, where a thickness m of the dielectric layer is calculated according to formula 1.

In one embodiment of the present disclosure, in the ion beam etching step in step S2, a working gas is trifluoromethane (CHF₃), ion energy is 200 eV to 600 eV, an ion beam current is 50 mA to 160 mA, an accelerating voltage is 200 V to 260 V, and a working pressure is 2.4×10⁻² Pa. In one embodiment of the present disclosure, in step S1, the substrate coated with the photoresist film is placed into a holographic interference optical system for exposure.

Compared with the prior art, the above technical solutions of the present disclosure have the following advantages.

The transmission grating according to the present disclosure includes a substrate, a grating layer, and a dielectric layer that are sequentially disposed in the thickness direction of the transmission grating, where the grating layer includes trapezoidal grating teeth arranged in an array on the substrate, and the dielectric layer covers the surface of the grating layer and is capable of completely filling the gaps between adjacent grating teeth. Specifically, a side of the dielectric layer away from the substrate has a second surface, and a difference exists between the distance from the second surface to the first surface of the substrate and the height of the grating layer. The difference is defined as m, and the difference m may also be considered as the thickness of the dielectric layer.

Compared with the prior art, the present disclosure can ensure that the gaps between the grating teeth are accurately filled, while also ensuring that the transmission diffraction efficiency is higher than 85% over the entire operating wavelength band and that a low degree of polarization is achieved. In addition, the grating groove profile of the transmission grating of the present disclosure is trapezoidal, which can reduce the difficulty of the processing process of the transmission grating compared with a rectangular groove profile, such that the duty cycle f of the transmission grating is greater than 0.39, and the aspect ratio is reduced to 1.65 to 1.76. In the present disclosure, by designing the film layer structure and film layer dimensions of the transmission grating, transmission gratings having different diffraction efficiencies and degrees of polarization can be obtained, and the dimensions of the film layer structure of the transmission gratings can be precisely controlled during processing, thereby facilitating processing.

### BRIEF DESCRIPTION OF THE DRAWINGS

To facilitate a clear understanding of the contents of the present disclosure, the present disclosure will be further illustrated in detail below according to specific embodiments of the present disclosure in conjunction with the drawings. In the drawings:

FIG. 1 is a schematic structural diagram according to a preferred embodiment of the present disclosure;

FIG. 2 is a technical flowchart of a preparation method according to a preferred embodiment of the present disclosure;

FIG. 3 is a schematic diagram of distribution of middle duty cycle and grating layer height when θ=84° according to Specific Embodiment 1 of the present disclosure;

FIG. 4 is a schematic diagram of distribution of diffraction efficiency and wavelength when H=1895 nm and the middle duty cycle is 0.45 according to Specific Embodiment 1 of the present disclosure;

FIG. 5 is a range distribution diagram of the grating layer height and duty cycle when the grating teeth are rectangular and the dielectric layer completely fills the rectangular groove profiles according to Specific Embodiment 1 of the present disclosure;

FIG. 6 is a schematic diagram of distribution of diffraction efficiency and wavelength when H=1980 nm and the duty cycle is 0.39 according to Specific Embodiment 1 of the present disclosure;

FIG. 7 is a schematic diagram of distribution of middle duty cycle and the grating layer height when θ=86° according to Specific Embodiment 2 of the present disclosure;

FIG. 8 is a schematic diagram of distribution of diffraction efficiency and wavelength when H=2060 nm and the middle duty cycle is 0.44 according to Specific Embodiment 2 of the present disclosure;

FIG. 9 is a range distribution diagram of the grating layer height and duty cycle when the grating teeth are rectangular and the dielectric layer completely fills the rectangular groove profiles according to Specific Embodiment 2 of the present disclosure; and

FIG. 10 is a schematic diagram of distribution of diffraction efficiency and wavelength when H=2170 nm and the duty cycle is 0.42 according to Specific Embodiment 2 of the present disclosure.

Description of reference numerals: 1, substrate; 10, first surface; 2, grating layer; 20, grating tooth; 3, dielectric layer; 30, second surface; 31, first film layer; and 32, second film layer.

### DETAILED DESCRIPTION OF THE PREFERRED EMBODIMENTS

The present disclosure will be further described below with reference to the drawings and specific embodiments, such that those skilled in the art can better understand and implement the present disclosure. However, the embodiments given should not be construed as limiting the present disclosure.

### Embodiment 1

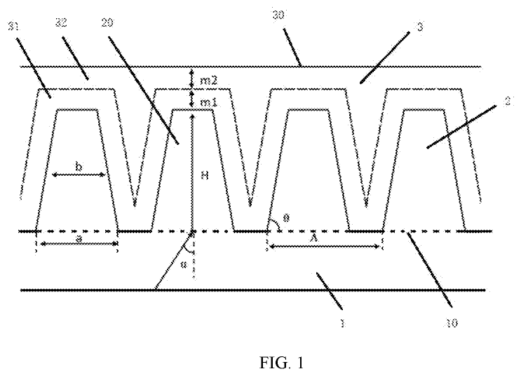

Referring to FIG. 1, the present disclosure discloses a transmission grating, including a substrate 1 having a first surface 10;
the transmission grating further includes a grating layer 2, the grating layer 2 includes a plurality of trapezoidal grating teeth 20 arranged in an array on the first surface 10, and a gap is formed between two adjacent grating teeth 20, such that a plurality of gaps are formed in the grating layer 2; and
the transmission grating further includes a dielectric layer 3, and the dielectric layer 3 is disposed on a surface of the grating layer 2 and fills the plurality of gaps. Specifically, the dielectric layer 3 is capable of covering the grating layer 2 and completely filling the plurality of gaps.

From a detailed perspective, the side of the dielectric layer 3 away from the substrate 1 has a second surface 30, and a difference exists between the distance from the second surface 30 to the first surface 10 and the height of the grating layer 2. The difference is denoted as m. It should be noted that the difference m may also be considered as the thickness of the dielectric layer 3, that is, the distance between the second surface 30 and the top of the grating tooth 20. A first interface is formed between the grating layer 2 and the dielectric layer 3, incident light is incident toward the first interface through the interior of the grating layer 2, a diffraction effect occurs on the first interface, the dielectric layer 3, and the second surface 30 to generate diffracted light and transmitted light, and the transmitted light is emitted through the second surface 30 of the dielectric layer 3.

It can be seen that the transmission grating claimed in the present disclosure includes a substrate, a grating layer, and a dielectric layer that are sequentially disposed in the thickness direction of the transmission grating, where the grating layer includes a plurality of trapezoidal grating teeth arranged in an array on the substrate, and the dielectric layer covers the surface of the grating layer and is capable of completely filling the gaps between adjacent grating teeth. Specifically, a side of the dielectric layer 3 away from the substrate has a second surface 30, and a difference exists between the distance from the second surface 30 to the first surface 10 of the substrate 1 and the height of the grating layer 2. The difference is defined as m, and the difference m may also be considered as the thickness of the dielectric layer 3, that is, the distance between the second surface 30 and the top of the grating tooth 20. Compared with the prior art, the present disclosure can ensure that the gaps between the grating teeth are accurately filled, while also ensuring that the transmission diffraction efficiency is higher than 85% over the entire operating wavelength band and that a low degree of polarization is achieved. In addition, the grating groove profile of the transmission grating of the present disclosure is trapezoidal, which can reduce the difficulty of the processing process of the transmission grating compared with a rectangular groove profile, such that the duty cycle f of the transmission grating is greater than 0.39, and the aspect ratio is reduced to 1.65 to 1.76.

From a detailed perspective, the second surface 30 of the dielectric layer 3 is parallel to the first surface 10, the dielectric layer 3 includes a first film layer 31 and a second film layer 32, the first film layer 31 covers the grating layer 2 and a portion of the substrate 1, and the second film layer 32 covers the first film layer 31. Specifically, in the height direction of the transmission grating and by using the geometric center line of the grating tooth 20 as a reference, the thickness of the first film layer 31 is denoted as m1, the thickness of the second film layer 32 is denoted as m2, and m=m1+m2. That is, the distance between the top of the grating tooth 20 and the upper surface of the first film layer 31 is denoted as m1, and the distance between the upper surface of the first film layer 31 and the second surface 30 is denoted as m2.

As a preferred embodiment, the first film layer 31 is a film layer of uniform thickness.

As a preferred embodiment, the plurality of grating teeth 20 are equally spaced apart from each other on the first surface 10 to form the grating layer 2.

Specifically, the cross-sectional shape of the grating tooth 20 in the height direction of the grating layer 2 is an isosceles trapezoid.

Further, the parameters are defined as follows:

The period A of the grating is 700 nm to 2000 nm.

The width of the bottom of the grating tooth 20 is a.

The width of the middle of the grating tooth 20 is b.

The height of the grating layer 2 is H.

The middle duty cycle f_{middle}=(b/∧) is 0.39 to 0.48, and the aspect ratio (H/∧) is 1.65 to 1.76. Further, the slanted side angle θ of the grating tooth 20 is 83 degrees to 88 degrees.

Therefore, the calculation formula of the difference m, i.e., the distance between the second surface 30 and the top of the grating tooth 20, that is, the thickness of the dielectric layer 3, is defined as:

$$m = {m}_{1} + {m}_{2} = \frac{p}{tan ( \frac{θ}{2} )} + \frac{H cos ( θ )}{1 - cos ( θ )} , Where \qquad ( formula 1 )$$

$$p = \frac{( 1 - {f}_{bottom} ) Λ}{2} and$$

$${f}_{bottom} = {f}_{middle} + \frac{H}{tan ( θ ) Λ} .$$

As a preferred embodiment, the dielectric layer 3 is made of a high-refractive-index material. The material of the dielectric layer 3 includes, but is not limited to, titanium dioxide (TiO₂), aluminum oxide (Al₂O₃), and tantalum pentoxide (Ta₂O₅).

From a detailed perspective, the substrate 1 is made of fused silica optical glass.

Therefore, by designing the film layer structure and film layer dimensions of the transmission grating, transmission gratings having different diffraction efficiencies and degrees of polarization can be obtained.

The following provides descriptions by using two specific embodiments.

### Specific Embodiment 1

Methane is a greenhouse gas that has a significant impact on global climate change. By monitoring methane concentration, trends in global climate change can be evaluated more accurately. The atmospheric detection windows of methane are mainly at 1.6 μm and 2.3 μm. In this embodiment, a transmission grating was provided for the 1.6 μm wavelength band, which mainly consisted of a fused silica substrate, and a grating layer and a dielectric film layer disposed thereon.

The grating layer included etched grating groove profiles, the grating groove profiles were trapezoidal, a period of the grating was 1100 nm, and the dielectric film layer was made of TiO₂. Referring to FIG. 1, the incident angle α of incident light within the fused silica substrate 1 was set to 31 degrees.

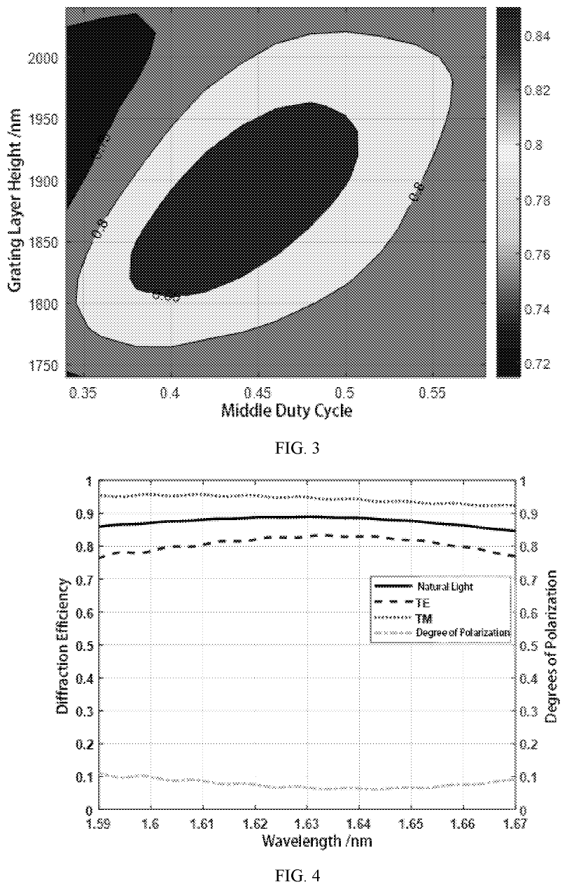

By optimizing the structure of the grating groove profiles, optimal parameters were obtained. When the grating was just fully filled with TiO₂ by atomic layer deposition, ranges of the grating layer height and duty cycle were obtained. With reference to FIG. 3 (θ=84°), it can be found that when the diffraction efficiency at the central wavelength band was greater than 85%, the required minimum grating layer height was 1810 nm. Accordingly, under conditions of a grating layer height of 1895 nm, an aspect ratio (H/A) of 1.72, and a middle duty cycle of 0.45, the first-order diffraction efficiency within the bandwidth range of 1.59 μm to 1.67 μm was calculated. As shown in FIG. 4, it can be seen that the first-order diffraction efficiencies within the bandwidth range of 1.59 μm to 1.67 μm were all greater than 85%.

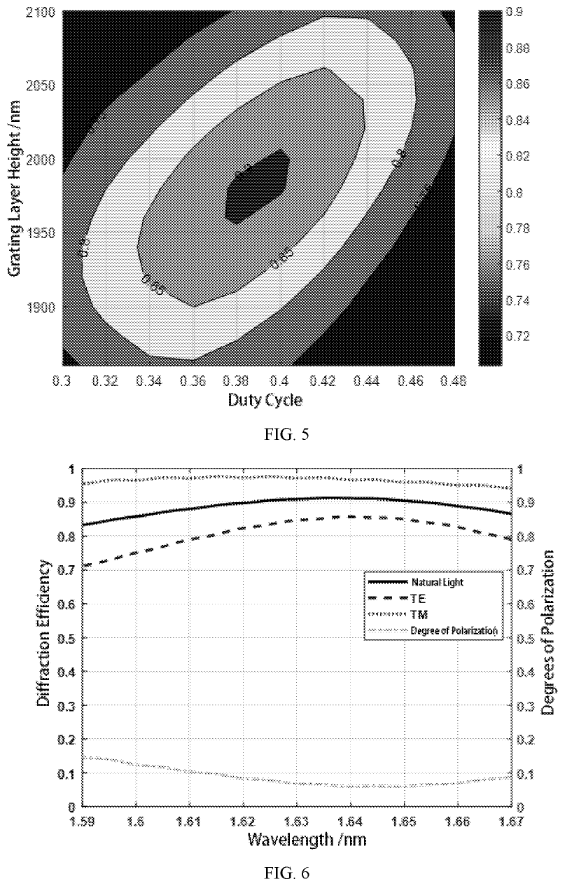

As shown in FIG. 5, compared with a conventional fully filled rectangular groove profile, when the grating was just fully filled with TiO₂ by atomic layer deposition, the ranges of the grating layer height and duty cycle were obtained. It can be found that when the diffraction efficiency at the central wavelength band was greater than 85%, the required minimum grating layer height was 1910 nm. Accordingly, under conditions of a grating layer height of 1980 nm, an aspect ratio (H/A) of 1.8, and a duty cycle of 0.39, the first-order diffraction efficiency within the bandwidth range of 1.59 μm to 1.67 μm was calculated. As shown in FIG. 6, it can be seen that the first-order diffraction efficiencies within the bandwidth range of 1.59 μm to 1.67 μm were greater than 80%.

Therefore, it can be clearly seen that by employing the novel trapezoidal grating groove profile design, the aspect ratio was effectively reduced, the duty cycle was increased, the degree of polarization was effectively reduced, and the first-order diffraction efficiency within the bandwidth range of 1.59 μm to 1.67 μm could be increased from 80% to 85%.

From a detailed perspective, during the preparation process, first, the fused silica substrate was coated with a photoresist, and then a photoresist grating mask was prepared on the photoresist by using a holographic lithography method, where the duty cycle f of the photoresist grating mask was equal to 0.45, and the grating layer height was 800 nm.

Subsequently, mask transfer was performed by reactive ion beam etching, and trapezoidal (slanted side angle θ=) 84° grooves were formed on the fused silica substrate. It should be noted that the height of the trapezoidal grooves was 1895 nm. Specifically, the reaction gas used was trifluoromethane (CHF₃), the ion energy was 550 ev, the ion beam current was 140 mA, the accelerating voltage was 240 V, and the working pressure was 2.5×10⁻² Pa.

After the remaining photoresist was removed, a layer of high-refractive-index material TiO₂ was formed by an atomic layer deposition method. According to the formula

$$m = {m}_{1} + {m}_{2} = \frac{p}{tan ( \frac{θ}{2} )} + \frac{H cos ( θ )}{1 - cos ( θ )} , where$$

$$p = \frac{( 1 - {f}_{bottom} ) Λ}{2} and$$

$${f}_{bottom} = {f}_{middle} + \frac{H}{tan ( θ ) Λ} ,$$

the thickness of the TiO₂ film layer was calculated to be 446 nm.

### Specific Embodiment 2

Carbon dioxide is a typical greenhouse gas that absorbs infrared radiation. It allows shorter-wavelength energy from the sun to pass through but strongly absorbs longer-wavelength infrared energy emitted from the Earth's surface and the near-surface atmosphere, thereby increasing surface temperature and forming a greenhouse effect, which has a significant impact on global climate change. By monitoring carbon dioxide concentration, trends in global climate change can be evaluated more accurately. The atmospheric detection windows of carbon dioxide are mainly at 1.61 μm and 2.06 μm. In this embodiment, a transmission grating was provided for the 2.06 μm wavelength band, which mainly consisted of a fused silica substrate, and a grating layer and a dielectric film layer disposed thereon.

Specifically, the grating layer included etched grating groove profiles, the grating groove profiles were trapezoidal and a period of the grating was 1250 nm, and the single-layer high-refractive-index dielectric film layer was made of TiO₂. The incident angle α of incident light within the fused silica substrate 1 was set to 38 degrees.

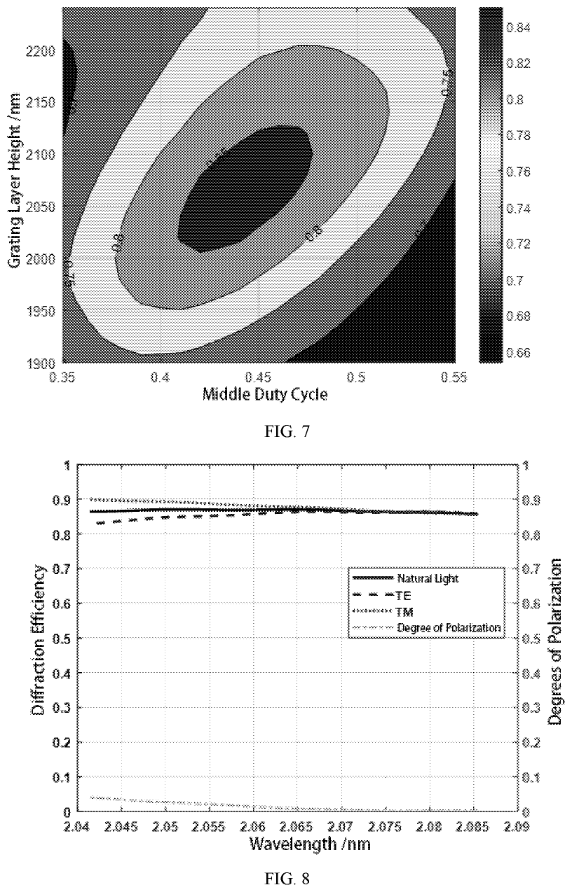

By optimizing the structure of the grating groove profiles, optimal parameters were obtained. When the grating was just fully filled with TiO₂, ranges of the grating layer height and duty cycle were obtained. As shown in FIG. 7 (θ=86°), it can be found that when the diffraction efficiency was greater than 85%, the required minimum grating layer height was 2010 nm. Accordingly, under conditions of a grating layer height of 2060 nm (H/∧=1.65) and a middle duty cycle of 0.44, the first-order diffraction efficiency within the bandwidth range of 2.042 μm to 2.086 μm was calculated, as shown in FIG. 8.

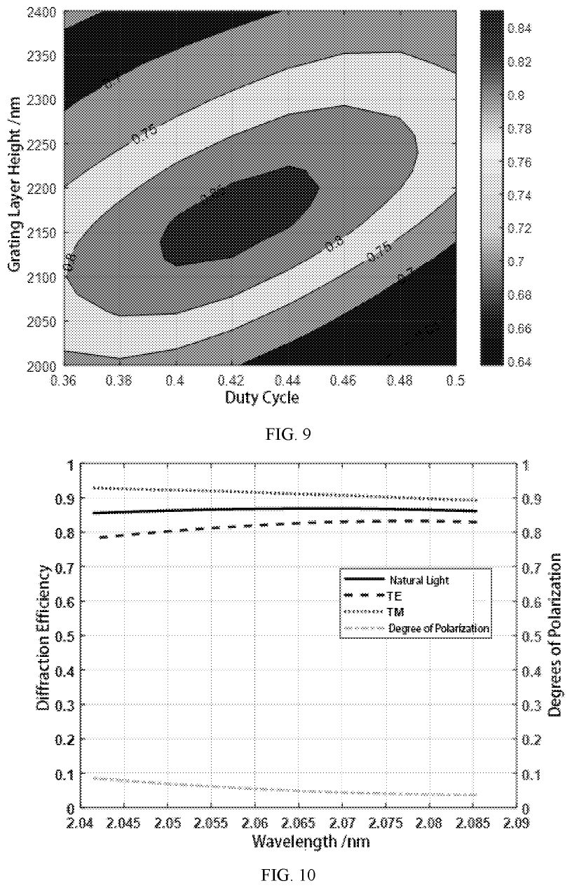

Compared with a conventional fully filled rectangular groove profile, as shown in FIG. 9, when the grating was just fully filled with TiO₂, the ranges of the grating layer height and duty cycle were obtained. It can be found that when the diffraction efficiency was greater than 85%, the required minimum grating layer height was 2115 nm. Accordingly, under conditions of a grating layer height of 2170 nm (H/∧=1.74) and a duty cycle of 0.42, the first-order diffraction efficiency within the bandwidth range of 2.042 μm to 2.086 μm was calculated, as shown in FIG. 10.

Therefore, it can be clearly seen that by employing the novel grating groove profile design, the aspect ratio of the grating was effectively reduced, the duty cycle was increased, and the degree of polarization was effectively reduced.

During the preparation process, first, the fused silica substrate was coated with a photoresist, and then a photoresist grating mask was prepared on the photoresist by using a holographic lithography method, where the duty cycle f of the photoresist grating mask was equal to 0.44, and the grating layer height was 960 nm.

Subsequently, mask transfer was performed by reactive ion beam etching, and trapezoidal (slanted side angle θ=86°) grooves were formed on the fused silica substrate. It should be noted that the height of the trapezoidal grooves was 2060 nm. Specifically, the reaction gas used was trifluoromethane (CHF₃), the ion energy was 450 ev, the ion beam current was 140 mA, the accelerating voltage was 240 V, and the working pressure was 2.5×10⁻² Pa.

After the remaining photoresist was removed, a layer of high-refractive-index material TiO₂ was formed by atomic layer deposition. According to the formula

$$m = {m}_{1} + {m}_{2} = \frac{p}{tan ( \frac{θ}{2} )} + \frac{H cos ( θ )}{1 - cos ( θ )} , where$$

$$p = \frac{( 1 - {f}_{bottom} ) Λ}{2} and$$

$${f}_{bottom} = {f}_{middle} + \frac{H}{tan ( θ ) Λ} ,$$

the thickness of the TiO₂ film layer was calculated to be 453 nm.

### Embodiment 2

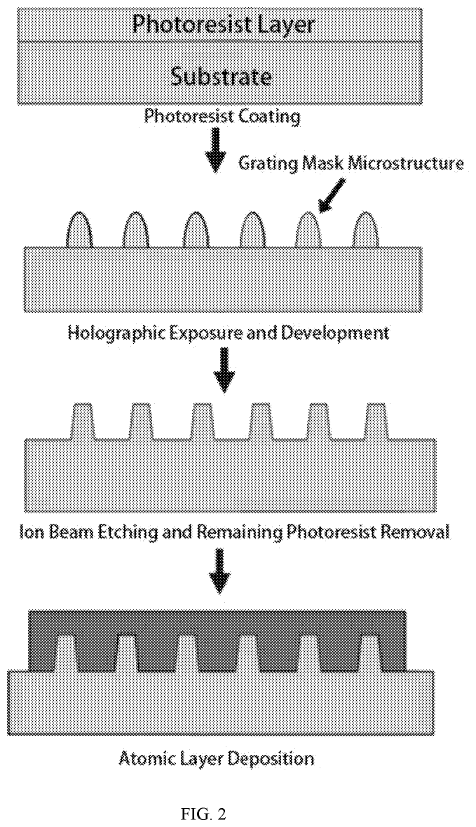

The present disclosure further discloses a preparation method for a transmission grating, and the method is used for preparing the transmission grating according to Embodiment 1. With reference to FIG. 2, the preparation method includes:
step S1, selecting a substrate 1, coating the substrate 1 with a photoresist, exposing the substrate coated with a photoresist film, and developing the exposed substrate in a developer to obtain a photoresist grating mask;
step S2, performing mask transfer by ion beam etching to transfer a grating mask pattern onto a surface of the substrate to form a grating layer 2; and
step S3, removing remaining photoresist, and forming a dielectric layer 3 on a surface of the grating layer 2 by atomic layer deposition.

The thickness m of the dielectric layer 3, i.e., the distance between the second surface 30 and the top of the grating tooth 20, is calculated by formula 1 in Embodiment 1.

$$m = {m}_{1} + {m}_{2} = \frac{p}{tan ( \frac{θ}{2} )} + \frac{H cos ( θ )}{1 - cos ( θ )} , where$$

$$p = \frac{( 1 - {f}_{bottom} ) Λ}{2} and$$

$${f}_{bottom} = {f}_{middle} + \frac{H}{tan ( θ ) Λ} .$$

As a preferred embodiment, in the ion beam etching step in step S2, the working gas is trifluoromethane (CHF₃), the ion energy is 200 eV to 600 eV, the ion beam current is 50 mA to 160 mA, the accelerating voltage is 200 V to 260 V, and the working pressure is 2.4×10⁻² Pa. As a preferred embodiment, in step S1, the substrate coated with the photoresist film is placed into a holographic interference optical system for exposure.

### Embodiment 3

The present disclosure further discloses an optical system, including the transmission grating according to Embodiment 1, where the angle of incident light ranges from 30° to 50°. The bandwidth of the incident light ranges from 1.5 μm to 2.1 μm.

In the present disclosure, by designing and adjusting the film layer structure and film layer dimensions of the transmission grating, transmission gratings having different diffraction efficiencies and degrees of polarization can be obtained. The present disclosure can ensure that the gaps between the grating teeth are accurately filled, while also ensuring that the transmission diffraction efficiency is higher than 85% over the entire operating wavelength band and that a low degree of polarization is achieved.

In addition, the grating groove profile of the transmission grating of the present disclosure is trapezoidal, which can reduce the difficulty of the processing process of the transmission grating compared with a rectangular groove profile, such that the duty cycle f of the transmission grating is greater than 0.39, and the aspect ratio is reduced to 1.65 to 1.76. In the present disclosure, by designing the film layer structure and film layer dimensions of the transmission grating, transmission gratings having different diffraction efficiencies and degrees of polarization can be obtained, and the dimensions of the film layer structure of the transmission gratings can be precisely controlled during processing, thereby facilitating processing.

In the description of the embodiments of the present disclosure, it should further be noted that unless otherwise explicitly specified and defined, the terms “arranged”, “disposed”, and “connected” should be interpreted in their broad senses. For example, “connected” may refer to a fixed connection, a detachable connection, or an integrated connection; a mechanical connection or an electrical connection; or a direct connection, an indirect connection via an intermediate, or internal communication between two elements. For those of ordinary skill in the art, the specific meaning of the above terms in the present disclosure may be interpreted according to specific conditions.

In the description of the present disclosure, it should be understood that the terms “first” and “second” are used for descriptive purposes only and are not to be construed as indicating or implying relative importance or implicitly indicating the number of technical features indicated. Therefore, a feature defined by “first” or “second” may explicitly or implicitly include one or more such features. In the description of the present disclosure, unless otherwise explicitly and specifically defined, “plurality of” means two or more than two.

In the present disclosure, unless otherwise explicitly specified and defined, the terms “mounted”, “interconnected”, “connected”, “fixed”, and the like should be interpreted in their broad senses. For example, “connected” may refer to a fixed connection, a detachable connection, or an integral formation; a mechanical connection or an electrical connection; or a direct connection, an indirect connection via an intermediate, or internal communication between two elements, or an interaction relationship between two elements. For those of ordinary skill in the art, the specific meaning of the above terms in the present disclosure may be interpreted according to specific conditions.

It is obvious that the above embodiments are merely examples for clear illustration and are not intended to limit implementations. Various changes and modifications can be made by those of ordinary skill in the art on the basis of the above description. It is unnecessary and impossible to exhaust all the embodiments herein. Obvious changes or modifications derived therefrom still fall within the protection scope of the present disclosure.

What is claimed is:

1. A transmission grating, comprising
a substrate having a first surface;
a grating layer, comprising trapezoidal grating teeth arranged in an array on the first surface, wherein a gap is formed between two adjacent grating teeth; and
a dielectric layer, disposed on a surface of the grating layer and filling the gap, wherein a side of the dielectric layer away from the substrate has a second surface, and a difference exists between a distance from the second surface to the first surface and a height of the grating layer, the difference being denoted as m,
wherein incident light is incident toward the second surface through an interior of the grating layer, and a diffraction effect occurs in the grating layer, the dielectric layer, and the second surface to generate transmitted diffracted light, the transmitted diffracted light being emitted through the second surface of the dielectric layer;
the dielectric layer comprises a first film layer and a second film layer, the first film layer covers the grating layer and a portion of the substrate, the second film layer covers the first film layer, a thickness of the first film layer is denoted as m1, and a thickness of the second film layer is denoted as m2; and
a calculation formula of m is defined as formula 1:
$$m = {m}_{1} + {m}_{2} = \frac{p}{tan ( \frac{θ}{2} )} + \frac{H cos ( θ )}{1 - cos ( θ )} , wherein$$
$$p = \frac{( 1 - {f}_{bottom} ) Λ}{2} ;$$
$${f}_{bottom} = {f}_{middle} + \frac{H}{tan ( θ ) Λ} ;$$
a slanted side angle θ of the grating tooth is 83 degrees to 88 degrees; a period A of the grating is 700 nm to 2000 nm, a width of a bottom of the grating tooth is denoted as a, a width of a middle of the grating tooth is denoted as b, the height of the grating layer is denoted as H, a middle duty cycle f_{middle}=(b/∧) is 0.39 to 0.48, and an aspect ratio (H/∧) is 1.65 to 1.76.

2. The transmission grating according to claim 1, wherein a cross-sectional shape of the grating tooth in a height direction of the grating layer is an isosceles trapezoid.

3. The transmission grating according to claim 1, wherein the dielectric layer comprises titanium dioxide (TiO₂), aluminum oxide (Al₂O₃), and tantalum pentoxide (Ta₂O₅).

4. The transmission grating according to claim 3, wherein the substrate is made of fused silica optical glass.

5. A preparation method for a transmission grating, used for preparing the transmission grating according to claim 1, comprising:
step S1, selecting a substrate, coating the substrate with a photoresist, exposing the substrate coated with a photoresist film, and developing the exposed substrate in a developer to obtain a photoresist grating mask;
step S2, performing mask transfer by ion beam etching to transfer a grating mask pattern onto a surface of the substrate to form a grating layer; and
step S3, removing remaining photoresist, and forming a dielectric layer on a surface of the grating layer by atomic layer deposition, wherein a thickness m of the dielectric layer is calculated according to the calculation formula of m, and the calculation formula of m is formula 1:
$$m = {m}_{1} + {m}_{2} = \frac{p}{tan ( \frac{θ}{2} )} + \frac{H cos ( θ )}{1 - cos ( θ )} , wherein$$
$$p = \frac{( 1 - {f}_{bottom} ) Λ}{2} ;$$
$${f}_{bottom} = {f}_{middle} + \frac{H}{tan ( θ ) Λ} ,$$
θ denotes a slanted side angle of the grating tooth, ∧ denotes a period of the grating, f_{middle} denotes a middle duty cycle, and H denotes a height of the grating layer.

6. The preparation method for a transmission grating according to claim 5, wherein in the ion beam etching in step S2, a working gas is trifluoromethane (CHF₃), ion energy is 200 eV to 600 eV, an ion beam current is 50 mA to 160 mA, an accelerating voltage is 200 V to 260 V, and a working pressure is 2.4×10⁻² Pa.

7. The preparation method for a transmission grating according to claim 5, wherein in step S1, the substrate coated with the photoresist film is placed into a holographic interference optical system for exposure.
